(19) United States
(12) Patent Application Publication
(10) Pub. No.: US 2022/0376222 A1
(43) Pub. Date: Nov. 24, 2022

(54) METHOD FOR MANUFACTURING AN ELECTRODE COMPRISING A POLYMER MATRIX TRAPPING AN ELECTROLYTE

(71) Applicants: COMMISSARIAT Á L'ÉNERGIE ATOMIQUE ET AUX ÉNERGIES ALTERNATIVES, Paris (FR); SOLVAY, Bruxelles (BE)

(72) Inventors: Jérémie Salomon, Grenoble (FR); Julio Abusleme, Saronno (IT); Benjamin Amestoy, Grenoble (FR); Marc-David Braida, Bry Sur Marne (FR); Hélène Rouault, Grenoble (FR); Dominique Bascour, Grezdoiceau (BE)

(21) Appl. No.: 17/753,754

(22) PCT Filed: Sep. 16, 2020
(86) PCT No.: PCT/FR2020/051599

§ 371 Date: Mar. 14, 2022

(30) Foreign Application Priority Data
Sep. 17, 2019 (FR) FR1910257

(51) Int. Cl. H01M 4/04; H01M 4/139; H01M 4/62

(52) U.S. Cl. CPC H01M 4/0411; H01M 4/139; H01M 4/623; H01M 2004/023

(57) ABSTRACT

A method for manufacturing an electrode comprising a polymer matrix trapping an electrolyte, the method comprising the following steps: a) a step of preparing a composition comprising the ingredients intended to be included in the constitution of the electrode; b) a step of forming the electrode, from the composition, on a support; wherein the composition prepared in step a) is a composition in paste form having a dynamic viscosity greater than 5000. Pa·s measured at a shear gradient of 0.1 s-1 and at ambient temperature; and wherein the preparation step consists in introducing the ingredients intended to be included in the constitution of the electrode into a mixer with two co-rotating interpenetrating screws rotating in a closed sleeve, and mixing the ingredients therein, the preparation step being implemented at a temperature less than 100° C.

### TECHNICAL FIELD

The present invention relates to a method for manufacturing an electrode comprising a polymer matrix trapping an electrolyte, more specifically, a liquid electrolyte able to form a gel with the polymer matrix (in which case the electrode may be referred to as an ionogel electrode), this electrode being provided to be incorporated in electrochemical accumulators.

The general field of the invention may be defined as that of energy storage devices, in particular, that of electrochemical accumulators.

### State of the Art

Electrochemical accumulators operate on the principle of electrochemical cells suitable for delivering an electric current by virtue of the presence in each of them of a pair of electrodes (respectively a positive electrode and a negative electrode) separated by an electrolyte, the electrodes comprising specific materials suitable for reacting according to an oxidation-reduction reaction, whereby there is an exchange of electrons at the origin of the electric current and an exchange of ions which will pass from one electrode to the other through the intermediary of an electrolyte.

Among the accumulators adopting this principle, accumulators operating on the principle of insertion/de-insertion of a metallic element taking place at the electrodes (and more specifically, on electrode active materials) and known by the term of metal-ion accumulators (for example, Li-ion, Na-ion, K-ion, Ca-ion, Mg-ion or Al-ion) have supplanted the other types of accumulator, such as lead-acid accumulators and Ni-MH accumulators, in particular for their performance in terms of energy density. As a matter of fact, M-ion accumulators, such as Li-ion accumulators, make it possible, in particular, to obtain gravimetric and volumetric energy densities (which may be greater than 180 Wh·kg⁻¹) appreciably greater than those of Ni-MH and Ni—Cd accumulators (which may range from 50 to 100 Wh·kg⁻¹) and lead-acid (which may range from 30 to 35 Wh·kg⁻¹).

From a functional standpoint, in metal-ion accumulators, the reaction at the origin of the production of current (that is to say when the accumulator is in discharge mode), involves the transfer, via an electrolyte that conducts metallic ions, of metallic cations coming from a negative electrode which become intercalated in the acceptor network of the positive electrode, while electrons coming from the reaction at the negative electrode will supply the external circuit, to which the positive and negative electrodes are connected.

More specifically, in the case of a Li-ion accumulator, the positive electrode may comprise, as lithium insertion material, lithium-based phosphatic materials (for example, LiFePO₄), a lithiated manganese oxide, optionally substituted (such as LiMn₂O₄), a lithium-nickel-manganese-cobalt based material LiNiₓMn_{y}Co_{z}O₂ with x+y+z=1 (also known by the abbreviation NMC), such as LiNi_{0.33}Mn_{0.33}Co_{0.33}O₂ or LiNi_{0.6}Mn_{0.2}Co_{0.2}O₂, a lithium-nickel-cobalt-aluminum based material LiNiₓCo_{y}Al_{z}O₂ with x+y+z=1 (also known by the abbreviation NCA), such as LiNi_{0.8}Co_{0.15}Al_{0.05}O₂.

As lithium insertion material, the negative electrode may comprise a carbonaceous material, such as graphite, a silicon-based compound, such as silicon carbide SiC or a silicon oxide SiOₓ, a lithiated titanium oxide, such as Li₄Ti₅O₁₂, a lithium-germanium alloy or for instance a mixture of several of these lithium insertion materials, such as a mixture comprising graphite and a silicon-based compound.

As mentioned above, between the negative electrode and the positive electrode there is disposed an electrolyte, which will enable the movement of ions (generally coming from a metallic salt present in the electrolyte) from the positive electrode towards the negative electrode on charging and vice-versa on discharging.

This electrolyte may take a liquid form and comprise, conventionally, one or more organic solvents (for example, a mixture of carbonate solvents), in which is (are) dissolved one or more metallic salts (for example, one or more lithium salts, when the accumulator is a lithium-ion accumulator).

However, the use of a liquid electrolyte has a certain number of drawbacks among the following:
the problem of leakage of the liquid electrolyte from the cell;
the possibility of the liquid electrolyte reacting chemically with the oxygen of the active material of the positive electrode, when thermal runaway occurs in the cell comprising that electrolyte, which may thus generate a large volume of gas, the consequence of which may be that the cell catches fire or even explodes.

To overcome these drawbacks, an alternative consists of dispensing with the use of a liquid electrolyte by replacing it, for example, with the following solutions:
a lithium ion conductor of glass or ceramic taking purely solid form, for example, a thin layer deposited by chemical vapor deposition (CVD) such as a layer of LIPON, or a layer of a composite material comprising a polymer matrix, for example, of poly(vinylidene fluoride), and a filler constituted by a lithiated oxide, such as Li₇La₃Zr₂O₁₂;
a dry polymer solid electrolyte composed of a polymer of the type polyoxyethylene (POE) and a lithium salt, for example lithium bis(trifluorosulfonyl)imidide (LiTFSI).

However, these different solutions all, at the present time, have a certain number of drawbacks.

Concerning the use of glass or ceramic lithium ion conductors, these require techniques of implementation or synthesis that are very complex to develop in an industrial context, which may prove prohibitive for the large-scale production of accumulators.

Concerning solid dry polymer electrolytes, their ionic conductivity, at ambient temperature, is generally less than 10⁻⁵ S·cm⁻¹, whereas, for a conventional liquid electrolyte, the ionic conductivity is of the order of 10⁻³ S·cm⁻¹, or even 10⁻² S·cm⁻¹ at ambient temperature. Due to this, it may prove necessary to use accumulators comprising a dry polymer electrolyte at higher temperatures than ambient temperature, for example at a temperature ranging from 60 to 80° C. to promote the diffusion of lithium ions within the electrolyte.

To mitigate the drawbacks linked to use of the liquid electrolyte and those of the solid electrolytes mentioned above, a new technology developed and illustrated in WO2015169835 consists of trapping the liquid electrolyte in a polymer matrix forming an integral part of the positive electrode and the negative electrode (which electrodes may be designated ionogel electrodes), this technology making it possible to obtain, at ambient temperature, electrochemical performance equivalent to that of a lithium-ion accumulator comprising a liquid electrolyte not trapped in a polymer matrix.

These electrodes are prepared in a conventional manner by a method successively comprising the following steps:
a step of manufacturing an ink (that is to say a liquid dispersion comprising the solid ingredients of the electrode in suspension) by mixing the various ingredients provided to enter into constitution of the electrode, which are, the active material, the electron conductor additive or additives, a fluorinated (co)polymer enabling the trapping of the liquid electrolyte, at least one solvent of that fluorinated copolymer (for example, acetone), a lithium salt, one or more electrolyte solvents (such carbonate solvents) to solubilize the lithium salt;
once the ink has been obtained, a step of depositing it, generally, by spreading on a substrate forming the current collector;
a step of evaporating the solvent or solvents of the fluorinated (co)polymer optionally followed by a calendering step whereby the specific electrode subsists.

The ink manufacturing step, which generally takes place in conventional mixers, such as a dispersing machine or a planetary mixer, requires a high proportion of solvent(s), which limits the percentage of solid mass in the ink. More specifically, the percentage of solid mass relative to the total mass of the ink is generally comprised between 35 and 49% by mass, whereas the mass of the liquid electrolyte (salt+electrolyte solvent(s)) is comprised between 6 and 13% of the total mass of the ink and the solvent or solvents of the fluorinated (co)polymer is comprised between 45 and 57% of the total mass of the ink.

The presence of such an amount of solvent(s) constitutes a limiting factor for the implementation of such a method, in particular at industrial scale, since it implies setting up management of effluents (here, the solvent used in high amount) whether in terms of safety (in particular, due to the potential inflammable nature of the solvent or solvents selected and/or the toxicity of the solvent or solvents selected) and the elimination of the solvent(s), which, moreover, generates high implementation costs for this method.

In this context, the inventors have set as an objective to provide a new method for manufacturing an electrode comprising a polymer matrix incorporating an electrolyte, which makes it possible to limit or possibly eliminate the use of a high amount of solvent(s) and which, thereby, is cheaper and limits the drawbacks linked to the use of large amounts of solvents(s).

### DISCLOSURE OF THE INVENTION

To that end, the inventors have developed a method for manufacturing an electrode which no longer involves the prior preparation of an ink but rather the prior preparation of a composition in the form of a paste comprising the ingredients provided to enter into the constitution of the electrode, this preparation being made possible by the use of a specific mixer during this step.

More specifically, in accordance with the invention, the method for manufacturing an electrode comprising a polymer matrix trapping an electrolyte comprises the following steps:

a) a step of preparing a composition comprising the ingredients provided to enter into the constitution of the electrode;

b) a step of forming the electrode on a substrate, from said composition;

characterized in that:
the composition prepared in step a) is a composition in the form of a paste having a dynamic viscosity greater than 5000 Pa·s measured at a shear rate of 0.1 s⁻¹ and at ambient temperature; and
the preparing step consists of introducing and mixing the ingredients provided to enter into the constitution of the electrode inside a mixer with two co-rotary interpenetrating screws rotating in a closed sleeve, said preparing step being implemented at a temperature less than 100° C.

Thanks to the use of this specific mixer, it is possible to use a smaller amount of solvent relative to a method using conventional mixers and thus limit the drawbacks linked to the management of effluents.

Firstly, the method of the invention comprises a step of preparing a composition in the form of paste comprising the ingredients constituting the electrode by introducing and mixing said ingredients inside a mixer with two co-rotary interpenetrating screws rotating in a closed sleeve.

The introduction of the ingredients may be simultaneous or successive and the introduction may be carried out on separate locations (for example, the introduction of the solid constituents at a first introduction zone via one or more entries of the mixer and the introduction of the liquid constituents at a second introduction zone via one or more entries of the mixer), as may be the case with the mixer illustrated in FIG. 3 appended hereto, which comprises:
a closed sleeve 1;
two interpenetrating screws 3 and 5;
a first ingredient introducing zone 7 (designated zone A);
a second ingredient introducing zone 9 (designated zone B) and;
an exit 11 for evacuating the composition formed;
a motor 13 connected to the screws to give rise to their rotation.

More specifically, this composition may comprise, as ingredients constituting the electrode:
at least one electrode active material;
at least one polymer provided to enter into the constitution of the polymer matrix;
an electrolyte;
optionally at least one electron conductor additive.

The electrode active material is a material suitable for inserting and de-inserting metal ions in its structure, such as alkali ions (for example, lithium ions, when the accumulator is a lithium accumulator, sodium ions, when the accumulator is an accumulator with sodium, potassium ions, when the accumulator is an accumulator with potassium), alkaline earth ions (for example magnesium ions, when the accumulator is an accumulator with magnesium, calcium ions, when the accumulator is an accumulator with calcium), metal ions (for example aluminum ions, when the accumulator is an aluminum-ion accumulator.

The nature of the active material depends of course on its purpose, i.e. whether it is provided for a positive electrode or a negative electrode.

Also, when the method of the invention is for the manufacture of a positive electrode, by way of example of electrode active materials capable of entering into the constitution of a positive electrode of a lithium accumulator, mention may be made of:
metallic chalcogenides of formula LiMQ2, in which M is at least one metallic element selected from the metallic elements, such as Co, Ni, Fe, Mn, Cr, V, Al and Q is a chalcogen, such as O or S, the preferred metallic chalcogens being those of formula LiMO₂, with M being as defined above, such as, preferably, LiCoO₂, LiNiO₂, LiNiₓCo₁₋ₓO₂ (with 0<x<1), a lithium-nickel-manganese-cobalt based material LiNiₓMn_{y}Co_{z}O₂ with x+y+z=1 (also known by the abbreviation NMC), such as LiNi_{0.33}Mn_{0.33}Co_{0.33}O₂, or a lithium-nickel-cobalt-aluminum based material LiNiₓCo_{y}Al_{z}O₂ with x+y+z=1 (also known by the abbreviation NCA), such as LiNi_{0,8}Co_{0.15}Al_{0.05}O₂;
chalcongenides of spinel structure, such as LiMn₂O₄;
lithiated or partly lithiated materials of formula M₁M₂(JO₄)_{f}E_{1-f}, in which M₁ is lithium, which may be partly substituted by another alkali element up to a degree of substitution of less than 20%, M₂ is a transition metal element of oxidation state +2 selected from Fe, Mn, Ni and combinations thereof, which may be partly substituted by one or more additional metallic elements of oxidation state(s) between +1 and +5 to a degree of substitution of less than 35%, JO₄ is an oxyanion in which J is selected from P, S, V, Si, Nb, Mo and combinations thereof, E is a fluoride, hydroxide or chloride anion, f is the molar fraction of the oxyanion JO₄ and is generally comprised between 0.75 and 1 (including 0.75 and 1).

More specifically, the lithiated or partly lithiated materials may be based on phosphorus (which means, in other words, that the oxyanion satisfies the formula PO₄) and may have an ordered or modified olivine type structure.

Lithiated or partly lithiated materials may satisfy the specific formula Li₃₋ₓM′_{y}M″_{2-y}(JO₄)₃, in which 0≤x≤3, 0≤y≤2, M′ and M″ are identical or different metallic elements, at least one of M′ and M″ being a transition metal element, JO₄ is, preferably, PO₄, which may be partly substituted by another oxyanion with J selected from S, V, Si, Nb, Mo and combinations thereof.

The lithiated or partly lithiated materials may satisfy the formula Li(FeₓMn₁₋ₓ)PO₄, in which 0≤x≤1 and, preferably, x is equal to 1 ((which means, in other words, that the corresponding material is LiFePO₄).

When the method of the invention is for the manufacture of a negative electrode, by way of example of electrode active materials capable of entering into the constitution of a negative electrode of a lithium accumulator, mention may be mode of:
carbonaceous materials, such as graphitic carbon suitable for intercalating lithium and able to exist, typically, in the form of a powder, flakes, fibers or spheres (for example mesocarbon microbeads);
silicon-based compounds, such as silicon carbide SiC or silicon oxide SiOₓ;
metallic lithium;
lithium alloys, such as those described in U.S. Pat. No. 6,203,944 and/or WO 00/03444;
lithiated titanium oxides, such as an oxide of formula Li₍₄₋ₓ₎MₓTi₅O₁₂ or Li₄M_{y}Ti_{(5-y)}O₁₂ in which x and y range from 0 to 0.2, M is an element selected from Na, K, Mg, Nb, Al, Ni, Co, Zr, Cr, Mn, Fe, Cu, Zn, Si and Mo, a specific example being Li₄Ti₅O₁₂, these oxides being lithium insertion materials having a low degree of thermal expansion after having inserted lithium;
non lithiated titanium oxides, such as TiO₂;
oxides for formula M_{y}Ti_{(5-y)}O₁₂ in which y ranges from 0 to 0.2, and M is an element selected from Na, K, Mg, Nb, Al, Ni, Co, Zr, Cr, Mn, Fe, Cu, Zn, Si and Mo;
lithium-germanium alloys, such as those comprising crystalline phases of formula Li_{4.4}Ge; or
a mixture thereof, such as a mixture comprising graphite and a silicon-based compound.

The polymer or polymers suitable for entering into the constitution of the polymer matrix are, advantageously, selected from gelling polymers suitable for gelling in contact with the electrolyte and thus trapping the electrolyte (the resulting electrode thus forming an electrode commonly called an “ionogel electrode”) and, more specifically, may be selected from fluorinated polymers comprising at least one repeat unit arising from the polymerization of a fluorinated monomer and, preferably, at least one repeat unit arising from the polymerization of a monomer comprising at least one carboxylic acid group, optionally in the form of a salt.

It is to be understood that the repeat units arising from the polymerization of a fluorinated monomer, and, if any, the repeat unit or units arising from the polymerization of a monomer comprising at least one carboxylic acid group, optionally in the form of a salt, are chemically different repeat units and, in particular, the repeat unit or units arising from the polymerization of a fluorinated monomer do not comprise any carboxylic acid group(s), optionally in the form of a salt.

For gelling polymers, the repeat unit or units arising from the polymerization of a fluorinated monomer may be, more specifically, one or more repeat units arising from the polymerization of one or more ethylenic monomers comprising at least one fluorine atom and optionally one or more other halogen atoms, examples of monomers of this type being the following:
C₂-C₈ perfluoroolefins, such as tetrafluoroethylene and hexafluoropropene (also known as HFP);
C₂-C₈ hydrogenated fluoroolefins, such as vinylidene fluoride, vinyl fluoride, 1,2-difluoroethylene and trifluoroethylene;
perfluoroalkylethylenes of formula CH₂═CHR¹, in which R¹ is a C₁-C₆ perfluoroalkyl group;
C₂-C₆ fluoroolefins comprising one or more other halogen atoms (such as chlorine, bromine, iodine), such as chlorotrifluoroethylene;
(per)fluoroalkylvinylethers of formula CF₂═CFOR², in which R² is a C₁-C₆ fluoro- or perfluoroalkyl group, such as CF₃, C₂F₅, C₃F₇;
monomers of formula CF₂═CFOR³, in which R³ is a C₁-C₁₂ alkyl group, a C₁-C₁₂ alcoxy group or a C₁-C₁₂(per)fluoroalcoxy group, such as a perfluoro-2-propoxypropyl group; and/or
monomers of formula CF₂═CFOCF₂OR⁴, in which R⁴ is fluoro- or perfluoro-C₁-C₆-alkyl, such as CF₂, C₂F₅, C₃F₇ or a fluoro- or perfluoro-C₁-C₆-alkoxy group, such as —C₂F₅—O—CF₃.

More particularly, the gelling polymer(s) may comprise, as repeat unit(s) arising from the polymerization of a fluorinated monomer, a repeat unit arising from the polymerization of a monomer of the category of C₂-C₈ perfluoroolefins, such as hexafluoropropene, and a repeat unit arising from the polymerization of a monomer of the category of the C₂-C₈ hydrogenated fluoroolefins, such as vinylidene fluoride.

The repeat units or units arising from the polymerization of a monomer comprising at least one carboxylic acid group, optionally in the form of a salt may be, more specifically, one or more repeat units arising from the polymerization of a monomer of the following formula (I):

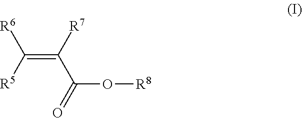

in which R⁵ to R⁷ are, independently of each other, a hydrogen atom or a C₁-C₃ alkyl group and R⁸ is a hydrogen atom or a monovalent cation (for example, an alkali cation, an ammonium cation), particular examples of monomers of this type being acrylic acid or methacrylic acid.

Particular gelling polymers which are usable in the context of the invention may be polymers comprising a repeat unit arising from the polymerization of vinylidene fluoride, a repeat unit arising from the polymerization of a monomer comprising at least one carboxylic acid group, such as acrylic acid and optionally a repeat unit arising from the polymerization of a fluorinated monomer different from vinylidene fluoride (and more specifically, a repeat unit arising from the polymerization of hexafluoropropene).

Still more particularly, gelling polymers usable in the context of the invention are gelling polymers of which the aforementioned repeat units arise from the polymerization:
of at least 70 mol % of a hydrogenated C₂-C₈ fluoroolefin, preferably vinylidene fluoride;
from 0.1 to 15 mol % of a C₂-C₈ perfluoroolefin, preferably hexafluoropropene; and
from 0.01 to 20 mol % of a monomer of the aforementioned formula (I), preferably acrylic acid.

Moreover, the gelling polymer or polymers advantageously have an intrinsic viscosity measured at 25° C. in N,N-dimethylformamide ranging from 0.1 to 1.0 L/g, preferably from 0.25 to 0.45 L/g.

More specifically, the intrinsic viscosity is determined by the equation below based on the fall time, at 25° C., of a the solution obtained by dissolving the polymer concerned in a solvent (N,N-dimethylformamide) at a concentration of approximately 0.2 g/dL using an Ubbelhode viscometer:

$$[ η ] = \frac{{η}_{sp} + Γ•ln {η}_{r}}{( 1 + Γ ) \cdot c}$$

in which:
η is the intrinsic viscosity (in dL/g);
c is the polymer concentration (in g/dL);
ηᵣ is the relative viscosity, that is to say the ratio between the fall time of the solution and the fall time of the solvent;
ηₛₚ is the specific viscosity, that is to say ηᵣ−1;
Γ is an experimental factor set at 3 for the polymer concerned.

The electrolyte is, advantageously, a liquid electrolyte and, more specifically, a liquid electrolyte able to gel in contact with the polymer matrix, when the latter comprises one or more gelling polymers.

The liquid electrolyte may comprise (or even consist of) at least one organic solvent, at least one metallic salt and optionally an additive belonging to the category of carbonaceous compounds (it being understood that this additive is different from the carbonate solvents that may be comprised, the case arising, in the electrolyte).

The organic solvent or solvents may be carbonate solvents, and, more specifically:
cyclic carbonate solvents, such as ethylene carbonate (symbolized by the abbreviation EC), propylene carbonate (symbolized by the abbreviation PC), butylene carbonate, vinylene carbonate, fluoroethylene carbonate, fluoropropylene carbonate and mixtures thereof;
linear carbonate solvents, such as diethyl carbonate (symbolized by the abbreviation DEC), dimethyl carbonate (symbolized by the abbreviation DMC), ethylmethyl carbonate (symbolized by the abbreviation EMC) and mixtures thereof.

The organic solvent or solvents may also be ester solvents (such as ethyl propionate or n-propyl propionate), nitrile solvents (such as acetonitrile) or ether solvents (such as dimethyl ether or 1,2-dimethoxyethane).

The organic solvent or solvents may also be ionic liquids, that is to say, conventionally, compounds formed by the combination of a positively charged cation and a negatively charged anion, which is in the liquid state at temperatures below 100° C. under atmospheric pressure.

More specifically, the ionic liquids may comprise:
a cation selected from the cations imidazolium, pyridinium, pyrrolidinium, piperidinium, quaternary ammonium, quaternary phosphonium, pyrazolium, said cations being optionally substituted, for example, by at least one alkyl group comprising from 1 to 30 carbon atoms;
an anion selected from halide anions, perfluorinated anions, borate anions.

Still more specifically, the cation may be selected from the following cations:
a pyrrolidinium cation of the following formula (II):

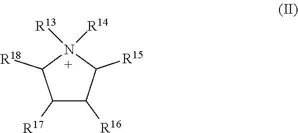

in which R¹³ and R¹⁴ are, independently of each other, a C₁-C₈ alkyl group and R¹⁵, R¹⁶, R¹⁷ and R¹⁸ are, independently of each other, a hydrogen atom or a C₁-C₃₀ alkyl group, preferably, a C₁-C₁₈ alkyl group, more preferably, a C₁-C₈ alkyl group;
a piperidinium cation of the following formula (II):

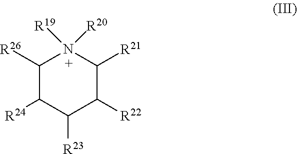

in which R¹⁹ and R²⁰ are, independently of each other, a C₁-C₈ alkyl group and R²¹, R²², R²³, R²⁴ and R²⁵ are, independently of each other, a hydrogen atom or a C₁-C₃₀ alkyl group, preferably, a C₁-C₁₈ alkyl group, more preferably, a C₁-C₈ alkyl group;
a quaternary ammonium cation;
a quaternary phosphonium cation;
an imidazolium cation; and
a pyrazolium cation.

In particular, the positively charged cation may be selected from the following cations:
a pyrrolidinium cation of the following formula (II-A):

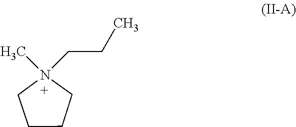

a piperidinium cation of the following formula (III-A):

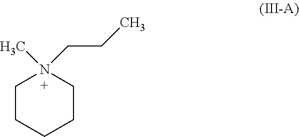

When it is a quaternary ammonium cation, it can be a tetraalkylammonium cation, a trialkylarylammonium cation or a tetraarylammonium cation, the alkyl groups, when present, being identical or different and may be linear or branched alkyl groups comprising from 4 to 12 carbon atoms, preferably from 4 to 6 carbon atoms, and the aryl groups, when present, being identical or different and being able to be a phenyl group, a benzyl group or a naphthyl group. More specifically, it can be a tetraethylammonium cation, a tetrapropylammonium cation, a tetrabutylammonium cation, a trimethylbenzylammonium cation, a methyltributylammonium cation, an N,N-diethyl-N-methyl-N-(2-methoxyethyl)ammonium cation, an N, N-dimethyl-N-ethyl-N-(3-methoxypropyl)ammonium cation, an N,N-dimethyl-N-ethyl-N-benzylammonium cation, an N,N-dimethyl-N-ethyl-N-phenylethylammonium cation, an N-tributyl-N-methylammonium cation, an N-trimethyl-N-butylammonium cation, an N-trimethyl-N-hexylammonium cation, an N-trimethyl-N-propylammonium cation.

When it is a quaternary phosphonium cation, it can be a tetraalkyphosphonium cation, a trialkylarylphosphonium cation or a tetraarylammonium cation, the alkyl groups, when present, being identical or different and able to be alkyl groups, groups, linear or branched, comprising from 4 to 12 carbon atoms, preferably from 4 to 6 carbon atoms, and the aryl groups, when present, being identical or different and being able to be a phenyl group, a benzyl group or a naphthyl group. More specifically, it may be a trihexyl(tetradecyl)phosphonium cation or a tetrabutylphosphonium cation.

When it is an imidazolium cation, it may be a 1,3-dimethylimidazolium cation, a 1-(4-sulfobutyl)-3-methylimidazolium cation, a 1-allyl-3H-imidazolium cation, a 1-butyl-3-methylimidazolium cation, a 1-ethyl-3-methylimidazolium cation, a 1-hexyl-3-methylimidazolium cation, a 1-octyl-3-methylimidazolium cation.

Specifically, the negatively charged anion may be selected from:
4,5-dicyano-2-(trifluoromethyl)imidazole (known by the abbreviation TDI);
bis(fluorosulfonyl)imidide (known as FSI);
bis(trifluoromethylsulfonyl)imidide of formula(SO₂CF₃)₂N⁻;
hexafluorophosphate of formula PF₆⁻;
tetrafluoroborate of formula BF₄⁻;
the oxaloborate of the following formula (IV):

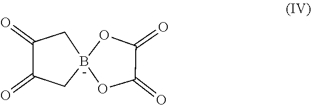

A specific ionic liquid usable according to the invention may be an ionic liquid composed of a cation of formula (II-A) as defined above and an anion of formula (SO₂CF₃)₂N⁻, PF₆⁻ or BF₄⁻.

The metallic salt or salts may be selected from the salts of the following formulae: MeI, Me(PF₆)ₙ, Me(BF₄)ₙ, Me(ClO₄)ₙ, Me(bis(oxalato)borate)ₙ (which may be designated by the abbreviation Me(BOB)ₙ), MeCF₃SO₃, Me[N(FSO₂)₂]ₙ, Me[N(CF₃SO₂)₂]ₙ, Me[N(C₂F₅SO₂)₂]ₙ, Me[N(CF₃SO₂)(R_{F}SO₂)]ₙ, in which R_{E} is a —C₂F₅, —C₄F₉ or —CF₃OCF₂CF₃, Me(AsF₆)ₙ, Me[C(CF₃SO₂)₃]ₙ, Me₂Sₙ, Me(C₆F₃N₄) (C₆F₃N₄ being 4, 5-dicyano-2-(trifluoromethyl)imidazole and, when Me is Li, the salt is lithium 4,5-dicyano-2-(trifluoromethyl)imidazole, this salt being known by the abbreviation LiTDI), in which Me is a metallic element and, preferably, a transition metal element, an alkali element or an alkaline earth element, and more preferably Me is Li (in particular, when the accumulator of the invention is a lithium-ion or lithium-air accumulator), Na (in particular, when the accumulator is a sodium-ion accumulator), K (in particular, when the accumulator is a potassium-ion accumulator) Mg (in particular, when the accumulator is a Mg-ion accumulator), Ca (in particular, when the accumulator is a calcium-ion accumulator) and Al (in particular, when the accumulator is an aluminum-ion accumulator), and n is the valence level of the metallic element (typically 1, 2 or 3).

When Me is Li, the salt is, preferably, LiPF₆.

The concentration of the metallic salt in the liquid electrolyte is, advantageously, at least 0.01 M, preferably at least 0.025 M, more preferably at least 0.05 M and, advantageously, at most 5 M, preferably, at most 2 M and, more preferably, at most 1M.

Furthermore, the liquid electrolyte may comprise at least one additive belonging to the class of carbonaceous compounds (it being understood that this additive is different from the carbonate solvent or solvents, if any, comprised in the electrolyte), such as vinylene carbonate or fluoroethylene carbonate, this additive being comprised in the electrolyte in an amount not exceeding 5 wt % of the total weight of electrolyte.

A liquid electrolyte that can be used, in particular when the electrode manufactured according to the method of the invention is for a lithium-ion accumulator, is an electrolyte comprising a mixture of carbonate solvents (for example, a mixture of cyclic carbonate solvents, such as a mixture of ethylene carbonate and propylene carbonate or a mixture of cyclic carbonate solvents and linear carbonate solvent(s), such as a mixture of ethylene carbonate, propylene carbonate and dimethyl carbonate), a lithium salt, for example LiPF₆ (e.g., 1M) and optionally an additive, such as vinylene carbonate or fluoroethylene carbonate.

As mentioned above, the composition may contain at least one electron conductor additive, that is to say an additive capable of conferring upon the electrode, in which it is incorporated, electron conductivity, it being possible, for example, for this additive to be selected from carbonaceous materials, such as carbon black, carbon nanotubes, carbon fibers (in particular, vapor grown carbon fibers known by the abbreviation VGCF), graphite in powder form, graphite fibers, graphene and mixtures thereof.

Furthermore, the composition may comprise at least one solvent (apart from, as the case may be, any organic solvent(s) of the electrolyte) of the polymer(s) provided to enter into the constitution of the polymer matrix, it being possible for this solvent to be a solvent from the family of ketones (such as acetone) when the polymer or polymers are selected from the family of fluorinated polymers comprising at least one repeat unit arising from the polymerization of a fluorinated monomer and, preferably, at least one repeat unit resulting from the polymerization of a monomer comprising at least one carboxylic acid group, optionally in the form of a salt. By virtue of the use of the specific mixer, this solvent or solvents may be used in a smaller amount relative to a method involving the use of a conventional mixer.

Where the composition comprises at least one solvent as mentioned above, the method advantageously comprises, after the forming step, an evaporating step, the evaporation for example being selective of the solvent or solvents of the polymer or polymers provided to enter into the constitution of the polymer matrix, for example by in-line drying by selective evaporation.

The preparing step is carried out at a temperature less than 100° C., preferably, at a temperature less than 80° C., and still more preferably, at a temperature less than 70° C. and, preferably, at a temperature greater than or equal to 5° C., more preferably, greater than or equal to 10° C., and still more preferably, greater than or equal to 15° C.

More specifically, the preparing step may be carried out at ambient temperature (that is to say the temperature of the surroundings, in which the preparation step takes place, without provision of heat by any heating element whatsoever, for example a temperature ranging from 15 to 35° C., and more specifically, a temperature equal to 25° C.) or may be carried out at a temperature above the ambient temperature, for example a temperature greater than the ambient temperature but less than 100° C. More specifically, the preparing step may be carried out at a temperature above the ambient temperature but less than the boiling temperature of the solvent or solvents of the polymer or polymers provided to enter into the constitution of the polymer matrix, when that solvent or those solvents are present in the composition or when that solvent or those solvents are not present, at a temperature greater than the ambient temperature but less than the melting temperature of the polymer or polymers provided to enter into the constitution of the polymer matrix (it being understood that the temperature at which the preparing step is carried out is always less than 100° C.).

The preparing step makes it possible to obtain a composition in the form of a homogenous paste having a very high dynamic viscosity, and more specifically, a dynamic viscosity greater than 5000 Pa·s, preferably greater than 6000 Pa·s and, more preferably greater than 7000 Pa·s, measured at a shear rate of 0.1 s⁻¹ and at ambient temperature.

It is to be noted that ambient temperature is understood to mean the temperature of the surroundings in which take places the dynamic viscosity measurement, without provision of heat by any heating element whatsoever, for example at a temperature ranging from 15 to 35° C., for example such as a temperature equal to 25° C.

More specifically, the dynamic viscosity of the composition is measured with a CVO Bohlin rheometer of the Malvern brand equipped with a Peltier support and a mobile cone-plane of diameter 40 mm and angle 4°. For this, the composition is deposited between the Peltier support and the mobile member with a gap of 150 μm. As the case may be, when the composition comprises at least one solvent of the polymer(s) constituting the polymer matrix, a solvent trap is added to the system to avoid excessively fast evaporation of the solvent(s). The measurement is carried out in viscometer mode at a shear rate of 0.1 s⁻¹ and at ambient temperature over an integration time of 5 seconds.

Moreover, the composition in paste form has, in general, a dynamic viscosity not exceeding 20000 Pa·s, preferably, not exceeding 18000 Pa·s, in the conditions as defined above (i.e., a shear rate of 0.1 s⁻¹ and at ambient temperature). Very advantageous results have been obtained, when the composition takes the form of a paste having a dynamic viscosity in the range from 7000 to 12000 Pa·s in the conditions defined above (i.e., a shear rate of 0.1 s⁻¹ and at ambient temperature).

As a matter of fact, a particularly advantageous aspect of the method of the invention lies in its capacity to enable the preparation of an electrode forming composition having a very high dynamic viscosity, which makes it possible to minimize the use of liquid electrolyte and/or of organic solvents. This is an advantage relative to the well-established techniques for manufacturing electrodes from inks manufactured based on conventional mixers of dispersing machine or planetary mixer type, that have a dynamic viscosity less than 5000 Pa·s, or possibly less than even 1000 Pa·s measured in the conditions measured above.

When the compositions comprise at least one solvent of the polymer(s) provided to enter into the constitution of the polymer matrix, these compositions may comprise, further to the preparing step, from 50 to 80% solid weight relative to the total weight of the composition.

More specifically, when the compositions comprise, as constituent ingredients, at least one electrode active material, at least one polymer provided to enter into the constitution of the polymer matrix, an electrolyte and optionally at least one electron conductor additive and at least one solvent of the polymer(s), the compositions obtained further to this preparing step advantageously have a percentage of solid weight relative to the total weight of the composition which may range from 50 to 80% (as compared to 35 to 49% with methods involving conventional mixers). Moreover, these compositions may comprise a weight of electrolyte amounting to 6 to 11% of the total weight of the composition and a weight of the solvent(s) of the polymer(s) amounting to 11 to 42% of the total composition (as compared to 45 to 57% with methods involving conventional mixers).

According to a particular and advantageous embodiment, the composition may be devoid of solvent or solvents of the polymer or polymers provided to enter into the constitution of the polymer matrix. In these conditions, the compositions may comprise, further to the preparing step, from 83 to 90% of solid mass relative to the total mass of the composition.

More specifically, when the compositions comprise, as constituent ingredients, at least one electrode active material, at least one polymer provided to enter into the constitution one of the polymer matrix, an electrolyte and optionally at least one electron conductor additive but are devoid of solvent(s) of the polymer or polymers, the percentage of said solid mass may be from 83 to 90% of the total mass of the composition and the mass of electrolyte may be from 10 to 17% of the total mass of the composition.

Under these conditions, the solvent evaporating step mentioned above is not necessary.

The preparing step may be carried out continuously, that is to say that introducing the ingredients and mixing them inside the specific mixer is performed continuously, that is to say for the whole duration of its implementation in the method.

The step for forming the electrode from the composition may be carried out by deposit via a die, for example a slot-die, said composition being conveyed, onto the substrate, via a die a purpose of which is the flow of the composition from a circular geometry to a rectangular geometry, so as to form a strip on the substrate.

Beforehand, the composition may optionally be laminated before accessing the substrate, so as to reduce its thickness, it being possible for the composition so laminated to be deposited on the substrate via an operation of co-laminating with the substrate.

Before the forming step and after the manufacturing step, the composition may transit within another mixer, for example, a conveying device under pressure, such as a monoscrew conveyor rotating in a closed sleeve and withstanding higher pressures than the mixture used at the manufacturing step, it being possible for the forming step in this case to be carried out also via a die disposed, preferably, at the outlet of the other mixer, this die also having the purpose of the flow of the composition from a circular geometry to a rectangular geometry, so as to form a strip on the substrate.

Before introduction inside the other mixer, such as a monoscrew conveyor, the composition may have the form of granules, these granules being formed at the outlet from the biscrew mixer used for the manufacturing step, for example by means of a rounded die disposed at the outlet from the mixer, so as to form a rod, this die being provided with a cutting system disposed at the outlet from the bi-screw mixer.

After the step of forming the electrode and the optional evaporating step, the method may further comprise a step of calendering the electrode, so as to increase the volumetric energy density.

The manufacturing method may be a continuous method, that is to say a method which takes place without interruption for the whole duration of its implementation, which, in other words, means that the electrode is manufactured without interruption for the whole duration of implementation of the method. In other words, this means that step a) and step b) are implemented concomitantly and without interruption for the whole duration of the method, which, in other words, means that at each instant t of the duration of the method, a fraction of the composition is subjected to the manufacturing step while another fraction of the composition is subjected to the forming step. It is also to be understood, in this case, that all the optional steps of the method (for example the laminating step, the drying step) are, when present, implemented continuously.

The invention will now be described in the light of the examples given below by way of non-limiting illustration.

### BRIEF DESCRIPTION OF THE DRAWINGS

FIG. 1 is a graph illustrating the change in voltage U (in V) as a function of the capacity C (in mAh/g) for the negative electrode obtained according to the method of Example 1, curve a) being that of the 1^{st} cycle and curve b) being that of the 2^{nd} cycle.

FIG. 2 is a graph illustrating the change in voltage U (in V) as a function of the capacity C (in mAh/g) for the positive electrode obtained according to the method of Example 3, curve a) being that of the 1^{st} cycle and curve b) being that of the 2^{nd} cycle.

FIG. 3, described earlier, is a cross-section view of a specific biscrew mixer usable in the context of the method of the invention.

### DETAILED DESCRIPTION OF SPECIFIC EMBODIMENTS

### Example 1

This example illustrates the manufacture by a continuous method in accordance with the invention of a negative electrode comprising 55% of solid mass relative to the total mass of the electrode.

In a first phase, an ionogel electrode paste is prepared by continuous introduction and mixing at 25° of the constituents of the electrode in the presence of acetone inside a mixer having two co-rotary interpenetrating screws rotating in a closed sleeve, the introduction being carried out, firstly, by the introduction of the solid constituents, then, secondly, by the introduction of the liquid constituents. The composition of the paste is as follows: 39.2 wt % of graphite (D₅₀=20 μm) 13.1 wt % of graphite (D₅₀=3.5 μm), 2.7 wt % of the copolymer constituting the polymer matrix (which copolymer is a copolymer comprising repeat units arising from the polymerization of vinylidene fluoride (96.7 mol %), acrylic acid (0.9 mol %) and hexafluoropropene (2.4 mol %) and having an intrinsic viscosity of 0.30 L/g in dimethylformamide at 25° C.), 37.5 wt % anhydrous acetone and 7.5 wt % 1M of LiPF₆ electrolyte in a mixture of ethylene carbonate and propylene carbonate (1:1) containing 2 wt % vinyl carbonate.

The dynamic viscosity of the composition was measured on a CVO Bohlin rheometer of the Malvern brand equipped with a Peltier mounting and a mobile cone-plane of diameter 40 mm and angle 4°. For this, the paste is deposited between the Peltier mounting and the mobile member with a gap of 150 μm, a solvent trap is added to the system to avoid excessively fast evaporation of the acetone and the measurement is made in viscometer mode at a shear rate of 0.1 s⁻¹ and 25° C. over an integration time of 5 seconds.

The dynamic viscosity measurement obtained is 7200 Pa·s.

In a second phase, the electrode paste so formed is spread, at the outlet of the specific mixer on a sheet of copper of 10 μm thickness, then dried and calendered, thereby forming an ionogel graphite electrode. The weight per unit area of the electrode is 11.3 mg/cm² (3.6 mAh/cm²) for a thickness of 90 μm. The capacity of the electrode was verified in a button cell against lithium metal.

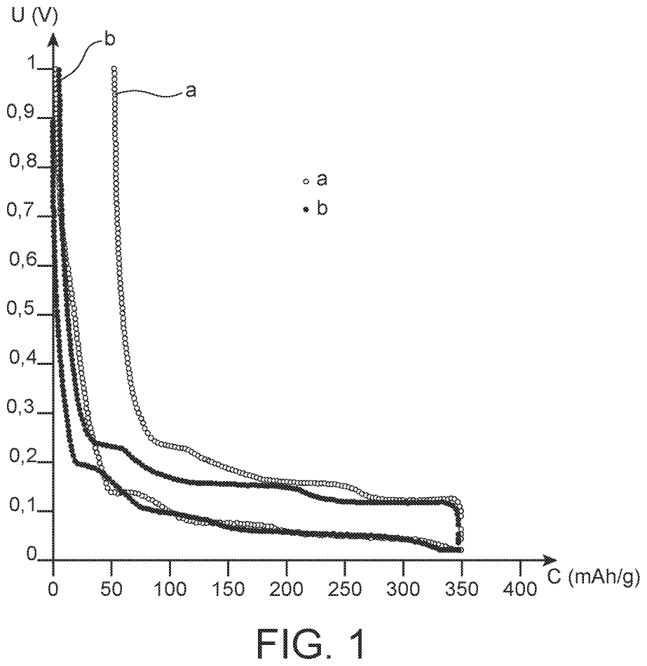

The total measured capacity is 350 mAh/g and the reversible capacity is 300 mAh/g at the 1^{st} cycle at C/20. The reversible capacity is 350 mAh/g at the 2^{nd} cycle at C/20, these data being illustrated in FIG. 1, showing the change in the voltage U (in V) as a function of the capacity C (in mAh/g), curve a) being that of the 1^{st} cycle and curve b) being that of the 2^{nd} cycle.

### Example 2

This example illustrates the manufacture of an ionogel electrode paste, said paste being prepared in accordance with the manufacturing step of the method of the invention and comprising 65% of solid mass relative to the total mass of the electrode.

This electrode paste is prepared by continuous introduction and mixing at 25° of the constituents of the electrode in the presence of acetone inside a mixer having two co-rotary interpenetrating screws rotating in a closed sleeve, the introduction being carried out, firstly, by the introduction of the solid constituents, then, secondly, by the introduction of the liquid constituents. The composition of the paste is as follows: 46.4 wt % of graphite (D₅₀=20 μm) 15.4 wt % of graphite (D₅₀=3.5 μm), 3.2 wt % of the copolymer constituting the polymer matrix (which copolymer is a copolymer comprising repeat units arising from the polymerization of vinylidene fluoride (96.7 mol %), acrylic acid (0.9 mol %) and hexafluoropropene (2.4 mol %) and having an intrinsic viscosity of 0.30 L/g in dimethylformamide at 25° C.), 24.2 wt % anhydrous acetone and 10.8 wt % 1M of LiPF₆ electrolyte in a mixture of ethylene carbonate, propylene carbonate and dimethyl carbonate (1:1:3) containing 2 wt % vinyl carbonate.

It was not possible to measure the dynamic viscosity of the composition obtained using a CVO Bohlin rheometer of the Malvern brand on account of too high a dynamic viscosity (appreciably greater than 10 000 Pa·s at a shear rate of 0.1 s⁻¹).

### Example 3

This example illustrates the manufacture by a continuous method in accordance with the invention of a positive electrode comprising 70% of solid mass relative to the total mass of the electrode.

In a first phase, an ionogel electrode paste is prepared by continuous introduction and mixing at 25° of the constituents of the electrode in the presence of acetone inside a mixer having two co-rotary interpenetrating screws rotating in a closed sleeve, the introduction being carried out, firstly, by the introduction of solid constituents, then, secondly, by the introduction of the liquid constituents. The composition of the paste is as follows: 65.8 wt % of LiNi_{0.33}Mn_{0.33}Co_{0.33}O₂, 2.8 wt % of an electron conductor additive, 1.4 wt % of the copolymer constituting the polymer matrix (which copolymer is a copolymer comprising repeat units arising from the polymerization of vinylidene fluoride (96.7 mol %), acrylic acid (0.9 mol %) and hexafluoropropene (2.4 mol %) and having an intrinsic viscosity of 0.30 L/g in dimethylformamide at 25° C.), 22.4 wt % anhydrous acetone and 7.6 wt % 1M of LiPF₆ electrolyte in a mixture of ethylene carbonate and propylene carbonate (1:1) containing 2 wt % vinyl carbonate.

The dynamic viscosity of the composition was measured on a CVO Bohlin rheometer of the Malvern brand equipped with a Peltier mounting and a mobile cone-plane of diameter 40 mm and angle 4°. For this, the paste is deposited between the Peltier mounting and the mobile member with a gap of 150 μm, a solvent trap is added to the system to avoid excessively fast evaporation of the acetone and the measurement is made in viscometer mode at a shear rate of 0.1 s⁻¹ and 25° C. over an integration time of 5 seconds.

The dynamic viscosity measurement obtained is 11 000 Pa·s.

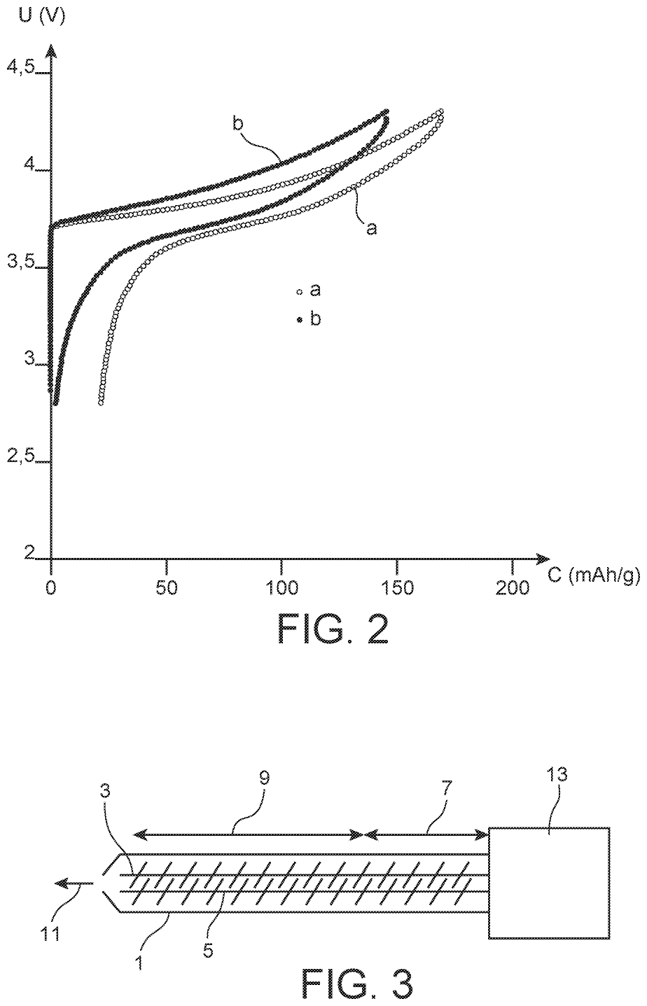

In a second phase, the electrode paste so formed is spread, at the outlet of the specific mixer on a sheet of aluminum of 20 μm thickness, then dried and calendered, thereby forming an ionogel graphite electrode. The weight per unit area of the electrode is 19.5 mg/cm² (2.9 mAh/cm²) for a thickness of 95 μm. The capacity of the electrode was verified in a button cell against lithium metal. The total measured capacity is 170 mAh/g and the reversible capacity is 147 mAh/g at the 1^{st} cycle at C/20. The reversible capacity is 143 mAh/g at the 2^{nd} cycle at C/20, these data being illustrated in FIG. 2, showing the change in the voltage U (in V) as a function of the capacity C (in mAh/g), curve a) being that of the 1^{st} cycle and curve b) being that of the 2^{nd} cycle.

### Example 4

This example illustrates the manufacture by a continuous method in accordance with the invention of a positive electrode comprising 80% of solid mass relative to the total mass of the electrode.

In a first phase, an ionogel electrode paste is prepared by continuous introduction and mixing at 25° of the constituents of the electrode in the presence of acetone inside a mixer having two co-rotary interpenetrating screws rotating in a closed sleeve, the introduction being carried out, firstly, by the introduction of solid constituents, then, secondly, by the introduction of the liquid constituents. The composition of the paste is as follows: 75.2 wt % of LiNi_{0,33}Mn_{0,33}Co_{0,33}O₂, 3.2 wt % of an electron conductor additive, 1.6 wt % of the copolymer constituting the polymer matrix (which copolymer is a copolymer comprising repeat units arising from the polymerization of vinylidene fluoride (96.7 mol %), acrylic acid (0.9 mol %) and hexafluoropropene (2.4 mol %) and having an intrinsic viscosity of 0.30 L/g in dimethylformamide at 25° C.), 11.3 wt % anhydrous acetone and 8.7 wt % 1M of LiPF₆ electrolyte in a mixture of ethylene carbonate and propylene carbonate (1:1) containing 2 wt % vinyl carbonate.

It was not possible to measure the dynamic viscosity of the composition obtained using a CVO Bohlin rheometer of the Malvern brand on account of too high a dynamic viscosity (appreciably greater than 10 000 Pa·s at a shear rate of 0.1 s⁻¹).

In a second phase, the electrode paste so produced is formed into a strip via a slot-die placed at the outlet of the mixer, the strip then being laminated to reduce its thickness then deposited by co-lamination on a current collector of aluminum to form the ionogel electrode.

### Example 5

This example illustrates the manufacture by a continuous method in accordance with the invention of a positive electrode comprising 90% of solid mass relative to the total mass of the electrode.

In a first phase, an ionogel electrode paste is prepared by continuous introduction and mixing at 25° of the constituents of the electrode in the presence of acetone inside a mixer having two co-rotary interpenetrating screws rotating in a closed sleeve, the introduction being carried out, firstly, by the introduction of solid constituents, then, secondly, by the introduction of the liquid constituents. The composition of the paste is as follows: 84.6 wt % of LiNi_{0.33}Mn_{0.33}Co_{0.33}O₂, 3.6 wt % of an electron conductor additive, 1.8 wt % of copolymer constituting the polymer matrix (which copolymer is a copolymer comprising repeat units arising from the polymerization of vinylidene fluoride (96.7 mol %), acrylic acid (0.9 mol %) and hexafluoropropene (2.4 mol %) and having an intrinsic viscosity of 0.30 L/g in dimethylformamide at 25° C.), 10 wt % 1M of LiPF₆ electrolyte in a mixture of ethylene carbonate and propylene carbonate (1:1) containing 2 wt % vinyl carbonate.

It was not possible to measure the dynamic viscosity of the composition obtained using a CVO Bohlin rheometer of the Malvern brand on account of too high a dynamic viscosity (appreciably greater than 10 000 Pa·s at a shear rate of 0.1 s⁻¹).

In a first phase, the electrode paste so produced is formed into a strip via a slot-die placed at the outlet of the mixer, the strip then being laminated to reduce its thickness then deposited by co-lamination on a current collector of aluminum to form the ionogel electrode.

What is claimed is:

1. Method for manufacturing an electrode comprising a polymer matrix trapping an electrolyte, said method comprising the following steps:
a) a step of preparing a composition comprising the ingredients provided to enter into the constitution of the electrode;
b) a step of forming the electrode on a substrate, from said composition;
wherein:
the composition prepared in step a) is a composition in the form of a paste having a dynamic viscosity greater than 5000 Pa·s measured at a shear rate of 0.1 s⁻¹ and at ambient temperature; and
the preparing step consists of introducing and mixing the ingredients provided to enter into the constitution of the electrode inside a mixer with two co-rotary interpenetrating screws rotating in a closed sleeve, said preparing step being implemented at a temperature less than 100° C.

2. Manufacturing method according to claim 1, wherein the composition comprises, as ingredients constituting the electrode:
at least one electrode active material;
at least one polymer provided to enter into the constitution of the polymer matrix;
an electrolyte;
optionally at least one electron conductor additive.

3. Manufacturing method according to claim 1, wherein the polymer or polymers are selected from gelling polymers suitable for gelling in contact with the electrolyte and thus trapping the electrolyte.

4. Manufacturing method according to claim 2, wherein the polymer or polymers are selected from fluorinated polymers comprising at least one repeat unit arising from the polymerization of a fluorinated monomer and, preferably, at least one repeat unit arising from the polymerization of a monomer comprising at least one carboxylic acid group, optionally in the form of a salt.

5. Manufacturing method according to claim 2, to wherein the electrolyte is a liquid electrolyte comprising at least one organic solvent, at least one metallic salt and optionally an additive belonging to the category of carbonaceous compounds.

6. Manufacturing method according to claim 2, wherein the composition further comprises at least one solvent of the polymer or polymers provided to enter into the constitution of the polymer matrix.

7. Manufacturing method according to claim 6, further comprising, after the forming step, a step of evaporating the solvent or solvents of the polymer or polymers provided to enter into the constitution of the polymer matrix.

8. Manufacturing method according to claim 2, wherein the composition is devoid of solvent or solvents of the polymer or polymers provided to enter into the constitution of the polymer matrix.

9. Manufacturing method according to claim 1, wherein the preparing step is implemented continuously.

10. Manufacturing method according to claim 6, wherein the preparing step is carried out at ambient temperature or is carried out at a temperature greater than the ambient temperature but less than 100° C.

11. Manufacturing method according to claim 6, wherein the preparing step is carried out at a temperature above the ambient temperature but less than the boiling temperature of the solvent or solvents of the polymer or polymers provided to enter into the constitution of the polymer matrix, when that solvent or those solvents are present in the composition or when that solvent or those solvents are not present, at a temperature greater than the ambient temperature but less than the melting temperature of the polymer or polymers provided to enter into the constitution of the polymer matrix.

12. Manufacturing method according to claim 2, wherein the composition further to the manufacturing step comprises from 50% to 80% of solid mass relative to the total mass of the composition, when it comprises a solvent or solvents of the polymer or polymers provided to enter into the constitution of the polymer matrix or comprises from 83 to 90% of solid mass relative to the total mass of the composition, when it does not comprise a solvent or solvents of the polymer or polymers provided to enter into the constitution of the polymer matrix.
